(19) United States
(12) Patent Application Publication
(10) Pub. No.: US 2021/0036288 A1
(43) Pub. Date: Feb. 4, 2021

(54) PAPER-BASED ALUMINUM-AIR BATTERIES AND BATTERY PACKS FOR PORTABLE APPLICATIONS

(71) Applicant: THE UNIVERSITY OF HONG KONG, Hong Kong (CN)

(72) Inventors: Yiu Cheong LEUNG, Hong Kong (CN); Yifei WANG, Hong Kong (CN); Yu Ho KWOK, Hong Kong (CN)

(21) Appl. No.: 16/767,029

(22) PCT Filed: Nov. 30, 2018
(86) PCT No.: PCT/CN2018/118428

§ 371 Date: May 26, 2020

Related U.S. Application Data
(60) Provisional application No. 62/593,420, filed on Dec. 1, 2017.

(51) Int. Cl. H01M 2/16; H01M 4/46; H01M 8/0232; H01M 8/0234; H01M 12/06

(52) U.S. Cl. CPC H01M 2/1626; H01M 2/1673; H01M 2/168; H01M 12/065; H01M 8/0232; H01M 8/0234; H01M 4/463

(57) ABSTRACT

An aluminum-air battery is provided. The battery comprises a hydrophilic and porous electrolyte substrate, a conductive layer comprising aluminum on one surface of the electrolyte substrate or inside the electrolyte substrate as battery anode, an oxygen reduction catalyst on an opposite surface of the electrolyte substrate as battery cathode, and an electrolyte either applied to the electrolyte substrate externally or pre-deposited into the electrolyte substrate. A battery shell can be employed for a multi-use rigid battery design, or it can be eliminated for a single-use flexible battery design.

### FIELD OF THE INVENTION

The present invention relates generally to a metal-air battery and battery pack, which can be mechanically recharged or directly disposed after usage. The present invention can be either a rigid or a flexible battery.

### BACKGROUND

Research and development of aluminum-air batteries around the world has traditionally focused on developing better materials for different batteries components, such as more corrosion-resistant aluminum anode, oxygen reduction catalyst with higher electro-catalytic efficiency, and stronger corrosion inhibitor in the electrolyte. Most of the existing aluminum-air battery prototypes utilize an aqueous solution as the electrolyte, which is either static or continuously circulated inside the battery.

As a result of a water management sub-system that has to be integrated into the battery, current aluminum-air batteries can lose their appeal when compared with conventional dry batteries for low power devices. Furthermore, the parasitic energy loss and leakage hazard can occur when a circulation configuration is set up. Additionally, aluminum-air batteries still utilize an aluminum anode with high purity, which greatly increases the battery cost. Furthermore, a large amount of liquid electrolyte has to be stored within the battery system, which weakens its superiority in high energy density.

As for the newly-emerged aluminum-air battery with gelled electrolyte, even though its system is greatly simplified due to the elimination of any liquid components, the self-corrosion of aluminum can start as soon as the battery is assembled, which greatly impairs the shelf-life of the battery. Moreover, ionic conductivity is sacrificed due to the polymerization of electrolyte, leading to a great loss in battery performance. Furthermore, battery discharge stability is also a problem as the generated aluminum hydroxide cannot be removed from the anode-electrolyte interface, which impedes further reaction of the anode.

### BRIEF SUMMARY

In certain embodiments of the subject invention, commercial aluminum foil and filter paper can be adopted as a battery anode and an electrolyte substrate, which can be conveniently replaced after usage so that the battery itself can be mechanically recharged. Certain embodiments can be either fully rigid or slightly flexible, depending on the intrinsic property of the battery shell. A face-to-face electrode configuration can decrease the ionic resistance and improve the battery power output.

Certain embodiments provide a modular design of paper-based aluminum-air battery pack based upon a single cell battery design, whose output voltage and power are adjustable according to the customer's need.

In another embodiment of the subject invention, the battery shell can be removed in order to make the battery structure fully flexible. A thin layer of aluminum anode can be fixed or deposited onto the electrolyte substrate by various methods known in the art. An air-breathing cathode can be deposited onto the electrolyte substrate using a cathode ink comprising oxygen reduction catalyst. Therefore, the whole battery is light-weight and fully disposable after single usage. In yet other embodiments, an aluminum anode can be embedded inside the electrolyte substrate, which can be followed by cathode ink deposition. Therefore, battery fabrication can be conveniently combined with the paper-making industry. In yet other embodiments, an aluminum ink can be adopted for anode deposition onto the electrolyte substrate, which can be followed by cathode ink deposition.

Moreover, certain embodiments include a paper-based solid electrolyte (PBSE), which comprises a polymerized electrolyte impregnated inside the paper skeleton. Compared with conventional gelled electrolyte, this solid electrolyte is much easier to fabricate and more cost-effective, which is also much easier to integrate with the paper-based aluminum-air batteries.

### BRIEF DESCRIPTION OF THE DRAWINGS

FIG. 1 shows a schematic diagram of the working principle and major components of the battery of the present invention.

FIG. 2 shows a diagram illustrating an embodiment of the rigid-type battery which employs nuts & bolts for assembly.

FIG. 3 shows a plot of a polarization curve of the embodiment in FIG. 2 when tested with 4M NaOH as electrolyte at room temperature.

FIG. 4 shows a plot of the discharge results of the embodiment in FIG. 2 at different discharge current densities.

FIG. 5 shows a diagram of an embodiment of the rigid-type battery prototype which employs buckles or magnets for assembly.

FIG. 6 shows a diagram of an embodiment of the rigid-type battery prototype which employs threads or pressure for assembly.

FIG. 7 shows a diagram of an embodiment of the rigid-type battery pack which stacks the single cells one on the top of the other.

FIG. 8 shows a plot of a polarization curve of the embodiment in FIG. 7 when tested with 4M NaOH as electrolyte at room temperature.

FIG. 9 shows a diagram of an embodiment of the rigid-type battery pack which integrates all the single cells in the same plane but utilizing independent electrolyte substrates.

FIG. 10 shows a diagram of an embodiment of the rigid-type battery pack which integrates all the single cells in the same plane but utilizing one common electrolyte substrate.

FIG. 11 shows a diagram of an embodiment of the flexible-type battery which employs adhesive tape to fix its aluminum anode onto the electrolyte substrate.

FIG. 12 shows a plot of a polarization curve of the embodiment in FIG. 11 when tested with 4M NaCl as electrolyte at room temperature.

FIG. 13 shows a diagram of an embodiment of the flexible-type battery which embeds its aluminum anode inside the electrolyte substrate.

FIG. 14 shows a plot of discharge results of the embodiment in FIG. 13 at 1 mA cm⁻² when using different mass of aluminum anode.

FIG. 15 shows a diagram of an embodiment of the flexible-type battery which employs an aluminum ink for the anode deposition.

FIG. 16 shows a plot of discharge results of the embodiment in FIG. 15 at various current densities when using 6 mg of aluminum anode.

FIG. 17 shows a diagram of an embodiment of a flexible-type battery pack which stacks the single cells one on the top of the other.

FIG. 18 shows a diagram of an embodiment of a flexible-type battery pack which integrates the single cells on one common electrolyte substrate.

FIG. 19 shows a diagram of a paper-based solid electrolyte for paper-based Al-air batteries, including its fabrication process, real prototype and cross-sectional composition (schematic).

FIG. 20 shows a diagram of an embodiment of a rigid-type battery which employs the paper-based solid electrolyte in FIG. 17.

FIG. 21 shows a plot of discharge result of the embodiment in FIG. 18 at 1 mA cm⁻².

FIG. 22 shows a diagram of an embodiment of a flexible-type battery which employs the paper-based solid electrolyte in FIG. 17.

FIG. 23 shows a plot of discharge result of the embodiment in FIG. 20 at 1 mA cm⁻².

### DETAILED DESCRIPTION

Embodiments of the subject invention provide an aluminum-air battery with at least one electrochemical cell for electricity generation that includes at least an aluminum anode, a hydrophilic and porous electrolyte substrate, an oxygen reduction cathode, and an electrolyte. The anode can be independent aluminum foil, plate or block from the electrolyte substrate, or it can be aluminum layer pre-fixed or pre-deposited onto the electrolyte substrate. The cathode can be independent oxygen reduction electrode from the electrolyte substrate, or it can be oxygen reduction catalyst pre-deposited onto the electrolyte substrate. The electrolyte can be an independent alkaline or a salt solution from the electrolyte substrate, or it can be pre-deposited into the electrolyte substrate. A hydrophilic polymer can also be blended with the pre-deposited electrolyte to lock in the water.

Embodiments of the subject invention provide an aluminum-air battery which can employ cellulose paper as electrolyte substrate to passively and restrictedly deliver a small amount of electrolyte solution to the battery electrodes. In addition to cellulose paper, other hydrophilic and porous materials such as cloth, cotton, or a sponge can be employed as the electrolyte substrate. The complex electrolyte delivery and management system in conventional aluminum-air batteries can be eliminated, leading to a greatly simplified system, and providing a greater range of viable battery options for low power applications. Moreover, restricting the supply of hydroxyl ions to the aluminum anode can reduce aluminum corrosion issues. Furthermore, certain embodiments of the battery can be either mechanically recharged instantaneously or be replaced directly, thereby reducing the waste to aluminum oxide, paper and electrolyte (alkaline or salt). Embodiments of the subject invention provide high energy density, fast start-up and termination, user safety, and a flexible structure.

An open-and-close battery shell can be employed to sandwich the core battery components (aluminum anode, electrolyte substrate and air-breathing cathode) inside, with only one portion of the electrolyte substrate exposed to accept either electrolyte solution or water only. The anode and cathode can be located on the opposite sides of the electrolyte substrate in order to decrease the extra ohmic resistance from the porous substrate. To increase output ability, a modular design of the corresponding battery pack, which can provide a flexible choice of voltage and power output according to customer's needs, is described herein. The inter-pack discharge loss can be reduced by separating the ionic connection among the single cells.

A flexible, shell-less battery can be realized by fixing or depositing a thin layer of aluminum as an anode onto one side of the electrolyte substrate, and depositing a thin layer of oxygen reduction ink as a cathode onto the other side of the electrolyte substrate. The fixing/deposition method of the anode can include taping, pasting, sewing, hot-pressing or physical vapor deposition. The deposition method for the cathode can include dip-coating, spray-coating, screen printing or inkjet printing. The cathode ink includes a suitable oxygen reduction catalyst, catalyst support, and catalyst binder.

In another embodiment a flexible, shell-less battery can be realized by embedding an aluminum anode inside the paper during the paper-making process, and depositing a thin layer of an oxygen reduction catalyst as a cathode onto the outside of the paper. This battery design can promote aluminum oxide recycling, as the generated aluminum oxide is well sealed inside the paper substrate.

In another embodiment a flexible, shell-less battery can be realized by developing an aluminum ink composed of aluminum micro-particles, carbon support and polymer binder in a solvent. The aluminum ink can be deposited onto the electrolyte substrate as anode by various methods such as dip-coating, spray-coating, screen printing and inkjet printing. A thin layer of an oxygen reduction catalyst is also deposited onto the opposite side as cathode.

Embodiments of the subject invention also provide a paper-based solid electrolyte for the paper-based aluminum-air batteries, in order to eliminate the necessity of liquid supply to the battery. Hydrophilic polymer can be added into a liquid electrolyte to prepare a gel electrolyte, which can be impregnated into a paper substrate and slightly dried. The as-prepared paper-based electrolyte can then be sealed in a container to prevent further loss of water, and can be conveniently assembled into the battery for work.

A greater understanding of the present invention and of its many advantages may be revealed from the following examples, given by way of illustration. The following examples are illustrative of some of the methods, applications, embodiments and variants of the present invention. They are, of course, not to be considered as limiting the invention. Numerous changes and modifications can be made with respect to the invention.

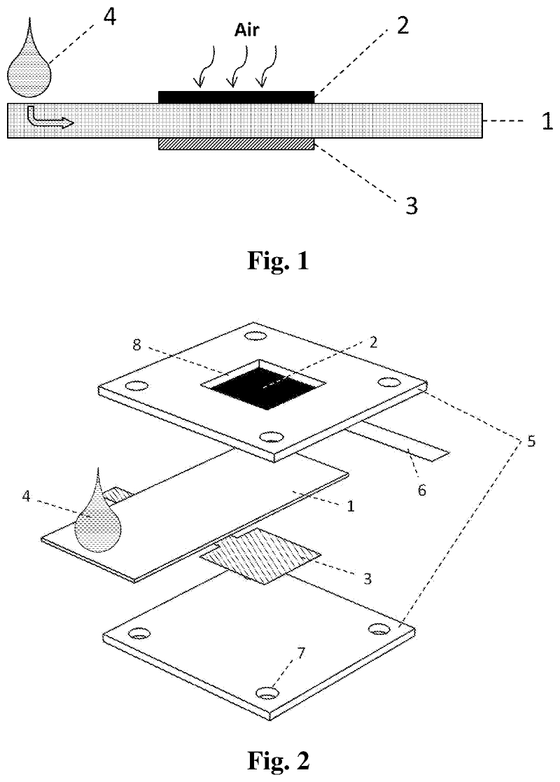

As shown in FIG. 1, an aluminum-air battery according to an embodiment of the subject invention can employ a hydrophilic and porous material as an electrolyte substrate 1. A small amount of electrolyte 4 can be applied to the electrolyte substrate 1. As the result of capillary action the electrolyte 4 can be wicked through the electrolyte substrate 1 to the reaction zone. The reaction zone can be disposed between an aluminum anode 3 and an air-breathing cathode 2. Alternatively, the electrolyte 4 can be pre-deposited onto the electrolyte substrate 1 so that only water is needed to activate the battery, or the electrolyte 4 can be polymerized first and then impregnated into the electrolyte substrate 1, so that no external liquid is needed for battery activation. During battery operation, the aluminum anode 3 can be oxidized and lose electrons. The generated free electrons will flow through the external circuit, producing electricity, and flow back to the cathode 2. At the interface between the electrolyte substrate 1 and the cathode 2, oxygen from the ambient air will receive the electrons and be reduced. Inside the electrolyte substrate, free ions can be transported between the aluminum anode 3 and air-breathing cathode 2 to complete the charge circuit.

Embodiments of the subject invention can be divided into two main categories. The first category is a rigid battery with an external battery shell (not shown in FIG. 1). In this case, different battery components such as the anode 3, cathode 2 and electrolyte substrate 1 can be independent from each other before the battery is assembled and the components can be replaced each time after they have been exhausted. The rigid battery design is suitable for repeatable usage, so high performance oxygen reduction catalysts such at Pt or MnO₂ can be adopted to further improve power output. The second category is a flexible battery that does not require an external battery shell. Instead, all the battery components can be integrated onto a single piece of electrolyte substrate 1. This type of battery can be for single-use only and be discarded after the aluminum anode 3 is consumed, so low-cost materials including oxygen reduction catalysts should be chosen in order to minimize the fabrication costs.

FIG. 2 illustrates a cell structure of a rigid-version battery cell. An air-breathing cathode 2 can be disposed inside a plastic shell 5. The cathode can include carbon paper. A piece of conductive foil 6, for example silver foil, can be electrically connected to one edge of the cathode 2 by a conductive adhesive, for example silver glue. The conductive foil 6 can function as a cathode current collector. An electrode window 8 or opening can be disposed within the plastic shell 5. The electrode window 8 can permit exposure of the cathode 2 to the ambient air. Another plastic shell 5 can be disposed below for support. The electrolyte substrate 1 can be disposed between the two plastic shells 5. An aluminum anode 3 can be disposed below the electrolyte substrate 1. The two plastic shells 5 can provide structure for the aluminum anode 3, the electrolyte substrate 1 and the air-breathing cathode 2 and be held together with adhesives or fasteners including nuts and bolts (not shown in FIG. 2) through the bolt holes 7. In order to minimize ionic transport resistance, the anode 3 and cathode 2 can be disposed such that one surface of the anode 3 directly faces one surface of the cathode 2. In order to hinder the cell from short-circuiting, the area of the electrolyte substrate 1 can be slightly larger than that of the aluminum anode 3. An electrolyte solution 4, such as potassium hydroxide, sodium hydroxide, sodium chloride or calcium chloride can be applied to an exposed end of the electrolyte substrate. The electrolyte solution 4 will be wicked to a reaction zone through disposed between the anode 3 and the cathode 2 by capillary action, thereby inducing an open-circuit voltage (OCV).

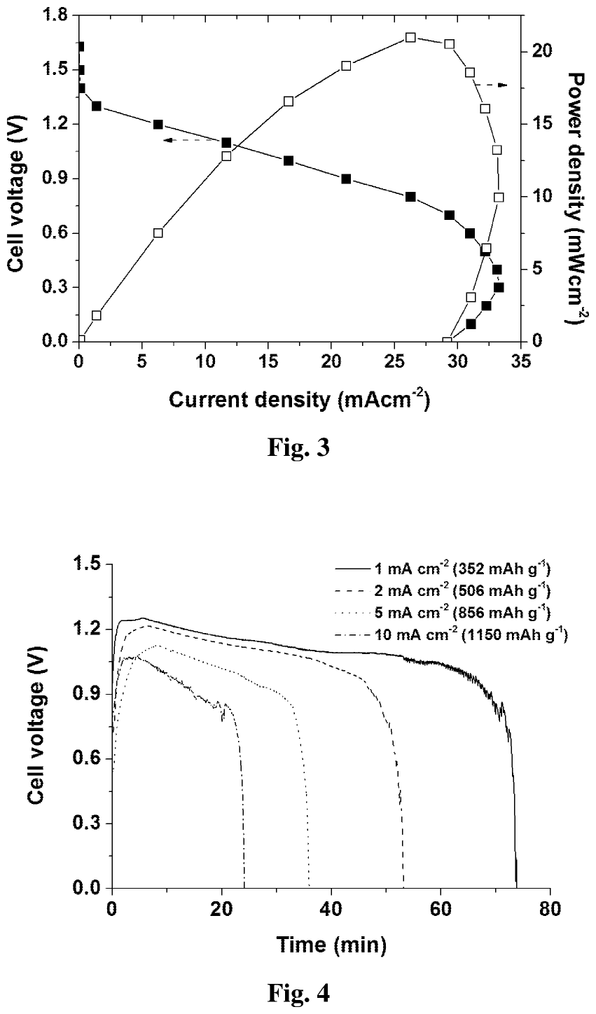

FIG. 3 shows a plot of battery performance of the embodiment illustrated in FIG. 2. In this embodiment, a commercial carbon paper without any catalyst coating is utilized as battery cathode 2, a commercial kitchen aluminum foil (98.2% purity) is utilized as battery anode 3, and a commercial filter paper is utilized as electrolyte substrate 1. 0.5 mL 4 M NaOH is selected as electrolyte 4 which has no corrosion additives inside. The battery can achieve an OCV of 1.65 V, a peak power density of 21 mW cm⁻², and a short-circuit current density of 29 mA cm⁻². The battery encounters an activation loss above 1.3 V. Between 1.3 to 0.8 V, the polarization curve is relatively straight, which is dominated by ohmic loss. Below 0.8 V, mass transport loss is evident which greatly restricts the battery current output. This is mainly due to the limited electrolyte solution 4 that can be absorbed by the present electrolyte substrate 1, so that a local shortage of hydroxide ions happens at the surface of the aluminum anode 3, which impedes further increase of the current density, or even decrease it. FIG. 4 shows a plot of the discharge results of a battery with 3.5 mg aluminum foil as an anode 3. The voltage over time curve shows that the battery can discharge stably at different current densities from 1 to 10 mA cm⁻², with the longest operation time of 74 min at 1 mA cm⁻² and the highest specific capacity of 1150 mA h g⁻¹ at 10 mA cm⁻². Higher discharge current densities are also possible if the thickness of the aluminum foil 3 and the filter paper 1 is increased. The battery can also be quickly put back to work by replacing the aluminum anode 3 and the electrolyte substrate 1. The waste product is mainly composed of Al₂O₃ and NaOH absorbed on the electrolyte substrate, which is disposable and can be directly burnt. The Al₂O₃ is also recyclable via the industrial Hall-Héroult process to regenerate the aluminum fuel.

In an embodiment as illustrated in FIG. 2, the electrolyte substrate 1 can also be hydrophilic porous materials other than filter paper, such as cloth, cotton pad, sponge and so on, which can be used for multiple times without severe distortion or tear apart. In this case, only the aluminum anode 3 needs to be replaced after the anode has been exhausted. The battery anode 3 can also be a thick aluminum plate or even a much thicker aluminum block, which can be immobilized on the bottom shell 5 with an extra conductive foil as anode current collector. In this case, the battery anode 3 can either be used for a greater period of time during continuous discharge, or be used multiple times, in which case only the electrolyte substrate 1 needs to be replaced after each time of discharge. The battery anode 3 can also be a layer of aluminum pre-deposited onto the electrolyte substrate 1 by physical vapor deposition, in which case the replacement of used battery components is more convenient. The battery anode 3 can also be aluminum foil fixed onto the surface of the electrolyte substrate 1 by taping, pasting, or sewing, or it can be embedded into the paper substrate 1 during the paper making process. In these cases, the replacing exhausted battery components can be more convenient. The battery cathode 2 can also be based on carbon cloth, nickel foam, stainless steel foam, etc. and various types of oxygen reduction catalysts such as platinum, manganese dioxide, perovskites, cobalt oxides, nitrogen-doped carbon, etc. can be added to the reaction side of the cathode 2, in order to further improve the battery performance. The electrolyte solution 4 can also be pre-deposited into the electrolyte substrate 1 and be completely dried, so that during battery operation only water is needed to be dropped onto the electrolyte substrate 1, which is much safer for battery users. Alternatively, the electrolyte solution 4 can be polymerized first by adding hydrophilic polymers such as polyacrylic acid or sodium polyacrylate into it, which is then impregnated into the electrolyte substrate 1 and slightly dried. In this case, no external liquid supply is needed any more, so the battery can work the same as conventional dry batteries.

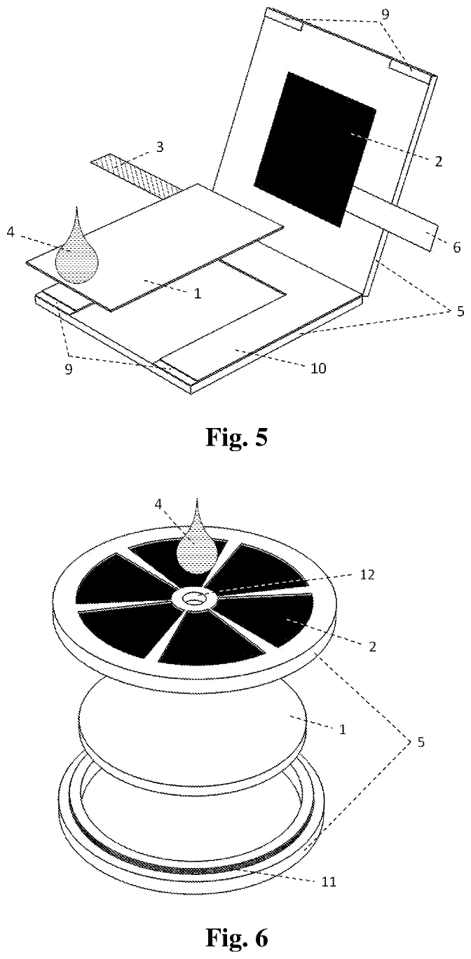

As seen in FIG. 5 the battery shell 5 can be a fold-shaped structure, which can be opened in order to remove and replace used battery components and closed during battery operation. To provide a mechanism for opening and closing the solid assembly, a buckle design 9 or a strong magnet design 9 can be employed. To increase user safety, a sealing layer 10 can also be added inside the battery shell 5 to surround the battery anode 3, electrolyte substrate 1 and battery cathode 2. It should be appreciated by one of ordinary skill in the art that the materials for the battery anode 3, electrolyte substrate 1 and battery cathode 2, can comprise a wide range of materials. The operation of this battery is also the same as described for the embodiment illustrated in FIG. 2.

As seen in FIG. 6, the battery shell 5 can be a can-shaped structure, which can be opened in order to remove and replace used battery components and closed during battery operation. To provide a mechanism for opening and closing the shell 5, a screw thread design 11 can be employed. Alternatively, a simple press-and-fixing design can be used without the screw thread 11. To provide electrolyte solution 4 or water into the electrolyte substrate 1, a feeding hole 12 can be opened in the top cover of the battery shell 5. If the pre-deposited electrolyte is polymerized, then the feeding hole 12 can be eliminated from the top cover 5. Similar to the embodiment shown in FIG. 5, a sealing gasket can be added to increase user safety (not shown in the Figure). It should be appreciated by one of ordinary skill in the art that the materials for the battery anode 3, electrolyte substrate 1 and battery cathode 2, can comprise a wide range of materials. The operation of this battery is also the same as described for the embodiment illustrated in FIG. 2.

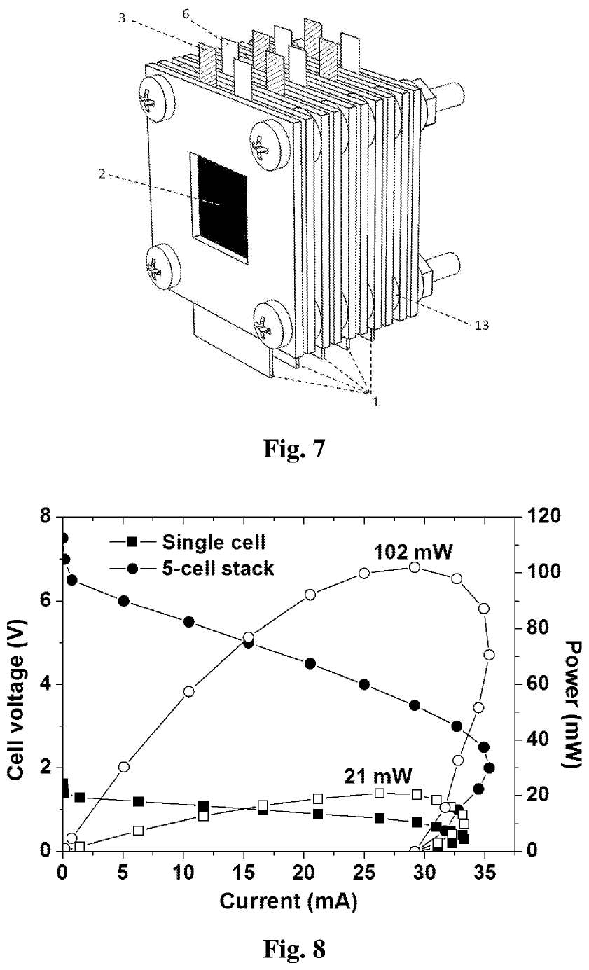

As seen in FIG. 7, an embodiment of the battery pack design comprises multiple single cells connected in series. The single cells can be configured to be similar to the embodiment shown in FIG. 2, with the exception of the current collectors 6 being moved to a single side of the battery shell 5. Separators 13 can be disposed between each pair of adjacent single cells in order to provide a region for the air exchange to the cathodes 2. Fasteners can be employed to assemble each single cell into one device. During operation, electrolyte solution can be provided to every end of the electrolyte substrates 1 separately. In order to avoid shunt current generation, the electrolyte substrates 1 can be disposed to prevent contact with each other. FIG. 8 shows a plot of the battery pack performance compared with a single cell of the battery. The battery pack as depicted in FIG. 7 coupled with a 1 cm⁻² electrode area for each single cell can achieve an OCV of 7.5V, a peak power output of 102 mW, and a short-circuit current of 29 mA. The efficiency of the battery pack calculated by the peak power output can be as high as 97%. Similar to the single cell case, the battery pack encounters severe activation loss above 6.5V and severe hydroxyl transport resistance below 3.5V. With further increment of the electrode area of the single cell, the present battery pack is competent for various applications in portable electronics, which can be mechanically recharged with fresh aluminum anode 3 and electrolyte substrate 1, and work for multiple times. Therefore, it is extremely suitable for outdoor activities, remote areas, and poverty districts where electric grid is not accessible. It should be appreciated by one of ordinary skill in the art that there are a wide choice of the battery component materials, which is already elaborated in the embodiment of FIG. 2. In addition, the number of single cells inside the battery pack can be varied to suit a particular application.

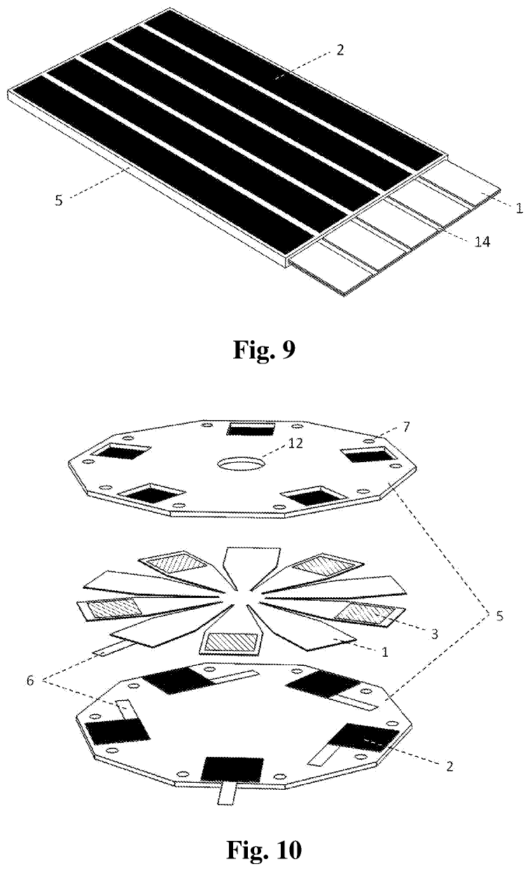

As seen in FIG. 9, another embodiment of a planar battery pack can be designed to improve the mechanical recharge process. The battery comprises a monolithic battery shell 5 and a plurality of single cell cathodes 2 disposed on the top surface of the battery shell 5. A hollow can be left in the middle of the battery shell 5 for inserting the replaceable electrolyte substrates 1 and battery anodes, which can be fixed onto a common piece of thin hydrophobic holder 14. The battery anodes (not shown in Figure) can be placed between the electrolyte substrates 1 and the hydrophobic holder 14. An internal electrical circuit can be utilized to connect the single cells in series after the hydrophobic holder 14, the electrolyte substrates 1, and the battery anodes are inserted into the battery shell 5. An electrolyte solution can be provided to each end of the electrolyte substrate 1. After a battery has been exhausted, another piece of hydrophobic holder 14 with fresh electrolyte substrates 1 and battery anodes can be inserted for further work, while the used one can be directly disposed without environmental hazards. It should be appreciated by one of ordinary skill in the art that the materials for the battery anode 3, electrolyte substrate 1 and battery cathode 2, can comprise a wide range of materials. The operation of this battery is also the same as described for the embodiment illustrated in FIG. 2. The hydrophobic holder 14, can comprise various types of plastics or cellulose papers with hydrophobic treatment. In addition, the number of single cells inside the battery pack can be configured to suit a particular application.

As seen in FIG. 10, another embodiment of the battery pack can comprise a circular design of the single cells connected in series. The battery pack can employ a single common electrolyte substrate 1 for all single cells. For easier connection, the adjacent single cells can have an opposite electrode configuration. In other words, one single cell can be configured, such that its anode 3 is disposed above its cathode 2, while an adjacent single cell can be configured such that its anode 3 is disposed below its cathode 2. As seen in FIG. 10, five cathodes 2 are disposed into the top battery shell 5, while the other five cathodes are disposed into the bottom battery shell 5. A flower-shaped electrolyte substrate 1 can be disposed between the battery shells 5. Aluminum anodes 3 can be integrated onto each petal of the electrolyte substrate 1. Five anodes 3 can be disposed on the top of the electrolyte substrate 1, while the other five anodes can be disposed on the bottom. It should be appreciated by one of ordinary skill in the art that the numbers of single cells can be configured to be suitable for specific applications. To hinder shunt current generation, an electrolyte can be pre-deposited into each reaction zone of the electrolyte substrate 1. During battery pack operation, water can be supplied to a middle portion of the electrolyte substrate 1 through the feeding hole 12 and flow to each single cell. In this manner, all the single cells can be ionically separated from each other, since the diffusion of electrolyte from the reaction zone to the middle of the electrolyte substrate 1 is greatly impeded by the capillary flow of water. After a single time of usage, the electrolyte substrate 1 with exhausted anodes 3 on it can be replaced with a fresh one for further work. It should be appreciated by one of ordinary skill in the art that the materials for the battery anode 3, electrolyte substrate 1 and battery cathode 2, can comprise a wide range of materials. The operation of this battery is also the same as described for the embodiment illustrated in FIG. 2. Furthermore, if a pre-deposited polymerized electrolyte is employed, then a water supply is no longer needed. This permits variation in the positioning of single cells in an arbitrary pattern, and the shape of the electrolyte substrate 1 can be arbitrary.

In some specific application fields, flexible and light-weight batteries are more preferable than conventional rigid and heavy ones. Specifically, when the device itself is single-use and disposable, the integrated battery inside it should be very cost-effective and environmental-friendly. These application fields include, but are not restricted to wearable electronics, smart packaging, point-of-care diagnostic, biosensor, emergency power supplier, RFID assemblies, advertising and promotion, consumer goods including but not restricted to toys, novelties, books greeting cards, and games, inventory tracking and control, security tags, indicators for condition including but not restricted to temperature, humidity, healthcare products including but not restricted to smart diapers, incontinence products, smart cards with components including but not restricted to integrated circuit, radio, audio/visual components, etc. To meet the above-mentioned requirements, another type of flexible battery design is also included in this specification for the subject invention, which no longer needs the relatively rigid and heavy battery shell for assembling purpose. Instead, all the battery components are integrated onto a single piece of electrolyte substrate.

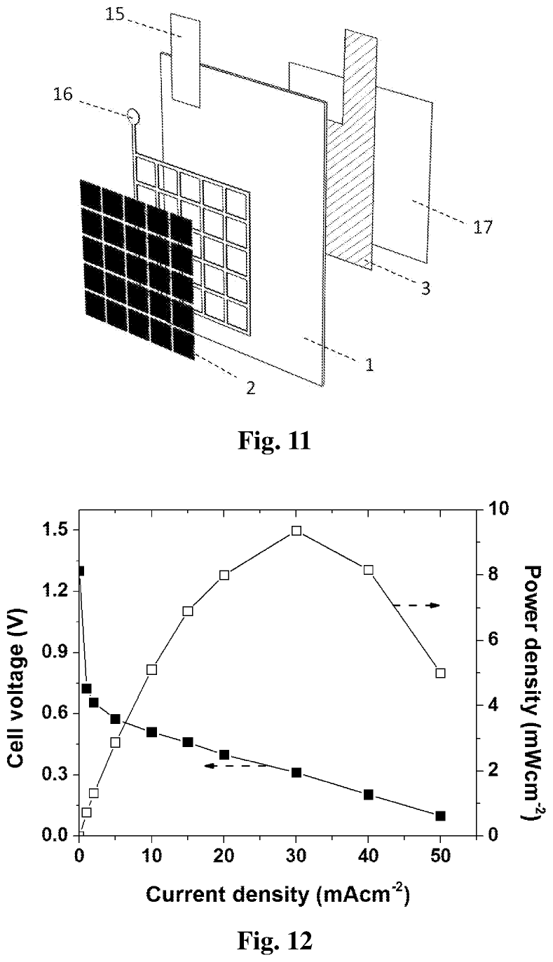

FIG. 11 illustrates a flexible battery cell structure according to an embodiment of the subject invention. A grid-shaped current collector 16 comprising conductive ink can be deposited onto an electrolyte substrate 1. A battery cathode 2 can be deposited within the current collector 16 onto the electrolyte substrate 1 by using an oxygen reduction ink. The oxygen reduction ink comprises a low-cost and non-noble oxygen reduction catalyst, (for example, manganese dioxide), a catalyst binder, (for example, Nafion), a catalyst support, (for example, carbon nanotubes), and an ink solvent, (for example, 50 vol. % ethanol solution). A current collector 16 can be connected to a connection end 15 which can be made of Cu tape. A thin layer of Al foil can be utilized as a battery anode 3 and disposed onto the electrolyte substrate 1 by an adhesive, (for example, a layer of adhesive tape 17). A hot-pressing treatment can be proceeded to increase the contact between the battery anode 3 and the electrolyte substrate 1. An electrolyte solution is provided from the bottom of the electrolyte substrate 1 and wicked to the reaction zone.

FIG. 12 shows a plot of the battery performance of the embodiment illustrated in FIG. 11, when 2 mg cm⁻² MnO₂/CNT (60 wt. % MnO₂) is utilized as the battery cathode 2, a commercial kitchen aluminum foil is utilized as the battery anode 3, and a commercial filter paper is utilized as the electrolyte substrate 1. 4 M NaCl solution is selected as electrolyte instead of any alkaline electrolytes in order to avoid the hydrogen generation, which may cause poor contact between the Al foil 3 and the filter paper 1. The battery can achieve an OCV of 1.3 V and a maximum power density of 9.4 mW cm⁻² at 30 mA cm⁻². Higher current density is also achievable but may lead to a quick discharge of the battery due to the small amount of aluminum anode 3. Therefore, this battery is more appropriately used for applications with low discharge current density, which can discharge stably for a long period of time.

In the embodiment illustrated in FIG. 11, the electrolyte substrate 1 can be hydrophilic porous materials other than filter paper, such as cloth, cotton pad, sponge, etc. In addition to taping, the battery anode 3 can be aluminum foil fixed onto the surface of the electrolyte substrate 1 by pasting or sewing or any other methods described herein. The battery anode 3 can be a layer of aluminum deposited onto the electrolyte substrate 1 by physical vapor deposition. The battery cathode 2 can be made of other types of non-noble oxygen reduction catalysts such as N-doped carbon, perovskites, cobalt oxides, etc. The grid-shaped current collector 16 can be made of various types of conductive inks such as copper ink or graphite ink, which can be even eliminated if the intrinsic conductivity of the oxygen reduction ink is high enough. The electrolyte solution can be pre-deposited into the electrolyte substrate 1 and completely dried, so that during battery operation only water is needed to be supplied to the electrolyte substrate 1, which is much safer for battery users. Alternatively, the electrolyte solution 4 can be polymerized first by adding hydrophilic polymers such as polyacrylic acid or sodium polyacrylate into it, which is then impregnated into the electrolyte substrate 1 and slightly dried. In this case, no external liquid supply is needed any more, and the battery can work the same as conventional dry batteries.

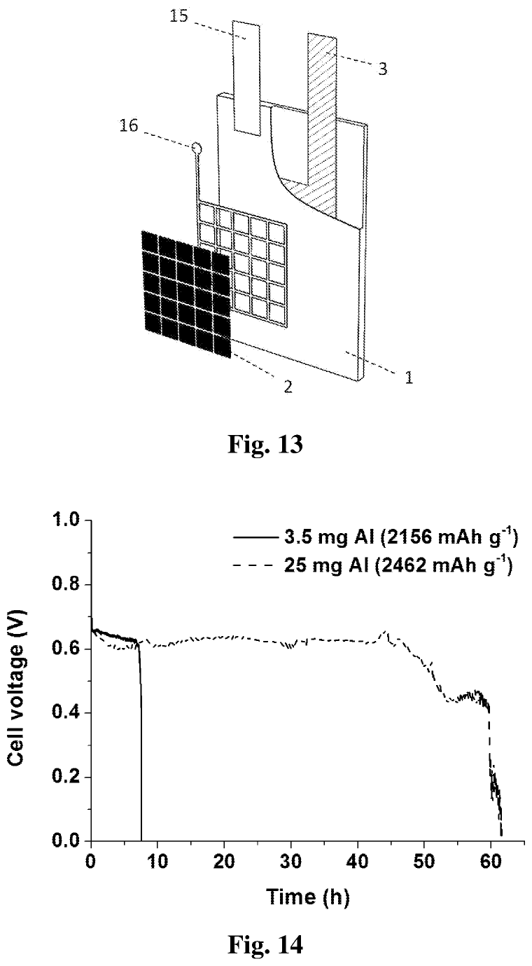

As seen in FIG. 13, an aluminum anode 3 can be embedded into a paper substrate 1 during the paper-making process. A layer of paper pulp can be spread onto a filter screen. An aluminum anode with a desired mass, shape and thickness can be placed onto a first layer of paper pulp. A second layer of paper pulp can be covered onto both the aluminum foil and the first layer of paper pulp in its periphery. Finally, all the layers can be pressed and dried to form an integrated product. The battery cathode 2 can be deposited onto one side or both sides of the paper substrate 1, of which the method is the same as that of the embodiment illustrated in FIG. 11. Due to the fine contact between the aluminum anode 3 and the paper substrate 1, this battery design can achieve a high discharge stability as shown in FIG. 14. The battery can be discharged at 1 mA cm⁻² for more than 7 hours when using 3.5 mg aluminum as anode, and for more than 60 hours when using 25 mg aluminum as anode.

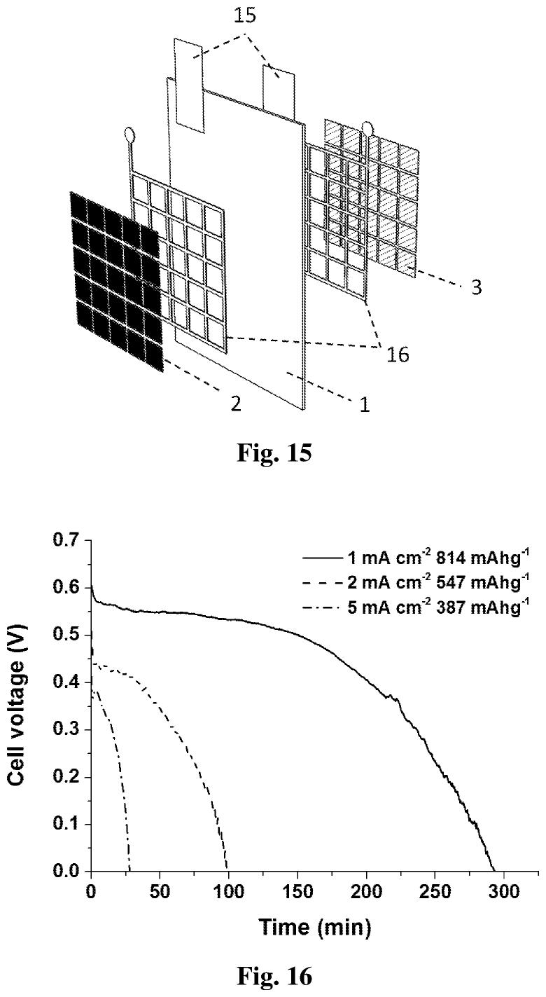

As seen in FIG. 15, an aluminum anode 3 can be deposited onto the electrolyte substrate 1 by using an aluminum ink. The aluminum ink is mainly composed of aluminum micro-particles, carbon supporter, polymer binder and a solvent. After anode deposition, the air-breathing cathode 2 can be deposited onto the other side of the electrolyte substrate 1, of which the method is the same as that of the embodiment illustrated in FIG. 11. Since both the electrodes are based on liquid inks, this flexible-type battery can be fully printable by various printing techniques such as screen printing and inkjet printing. The battery properties can be easily customized by controlling the printing parameters, such as the battery power output determined by printing area, and the battery energy capacity determined by printing times. In addition, a hot-pressing process can be adopted after ink printing to improve the battery performance. FIG. 16 shows the Galvanostatic discharge results of this printable battery design at different current densities. Apparently, the battery operation is more stable at lower current densities and the discharge efficiency is also higher. Therefore, it is more suitable for low current devices.

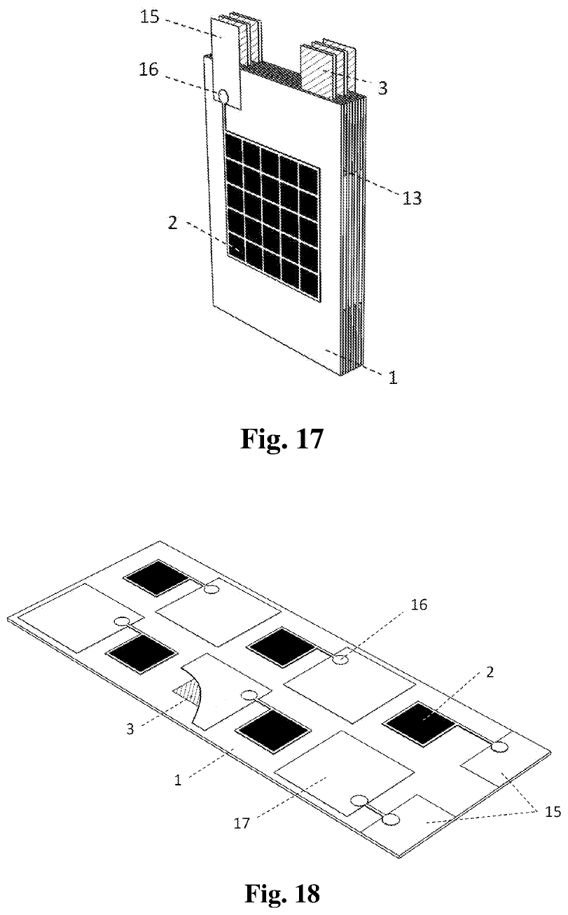

These flexible-type batteries can be stacked together into a battery pack to provide higher voltage and power outputs. FIG. 17 illustrates one embodiment, in which the battery pack has five single cells connected in series. The single cells are equivalent to the cell as described in the embodiment as shown in FIG. 11, FIG. 13 or FIG. 15. A hydrophobic separator 13 is added between each pair of adjacent single cells, to provide an area for the air exchange to the battery cathode 2. An electrolyte solution can be provided to each end of the electrolyte substrates 1 separately. In order to hinder shunt current generation, the electrolyte substrates 1 can be configured to avoid contact with each other. It should be appreciated by one of ordinary skill in the art that the materials for the battery components can comprise a wide range of materials. In addition, the number of single cells can be varied for suitability for specific application.

The multi-layer stacking method in FIG. 17 will slightly impair the system flexibility. To avoid this issue, the single cells can be integrated into a single common piece of electrolyte substrate 1, as shown in FIG. 18. For an easier connection, adjacent pairs of single cells can have an opposite electrode configuration. In other words, one single cell can be configured such that its anode 3 is disposed above its cathode 2, while an adjacent single cell can be configured such that its anode 3 is disposed below its cathode 2. Take the single cell in FIG. 11 for example: adhesive tape 17 can be utilized to fix the aluminum anode 3 onto the electrolyte substrate 1. If a conductive tape (such as copper tape) is utilized, the aluminum anode 3 can be fully covered and the tape itself can be used for electrical connection. If a non-conductive tape (such as plastic tape) is utilized, at least one portion of the aluminum anode 3 should be exposed to permit an electrical connection. The connection of single cells in FIG. 13 or 15 can also be achieved by similar methods. In addition, if a liquid electrolyte 4 is utilized to activate the battery pack, hydrophobic barriers can be added to the periphery of the single cells to cut off the potential ionic connection among them. This can be realized by impregnating a hydrophobic polymer (such as Ethyl cyanoacrylate) into the electrolyte substrate 1 in a desired pattern. If the polymerized electrolyte is utilized, such barriers may be no longer necessary. It should be appreciated by of ordinary skill in the art that the materials for the battery components can comprise a wide range of materials. In addition, the number of single cells inside the battery pack can be varied for suitability with a specific application.

The preparation and application of the paper-based solid electrolyte (PBSE) 18 in paper-based Al-air batteries are further elaborated in the following sections. The PBSE 18 is prepared by impregnating gel electrolyte 19 into the electrolyte substrate 1, followed by a solution casting process to solidify the gel. The as-prepared PBSE 18 can either be used in the rechargeable rigid-type battery, or be integrated into the single-use flexible-type battery, in order to achieve liquid-free operation of the battery.

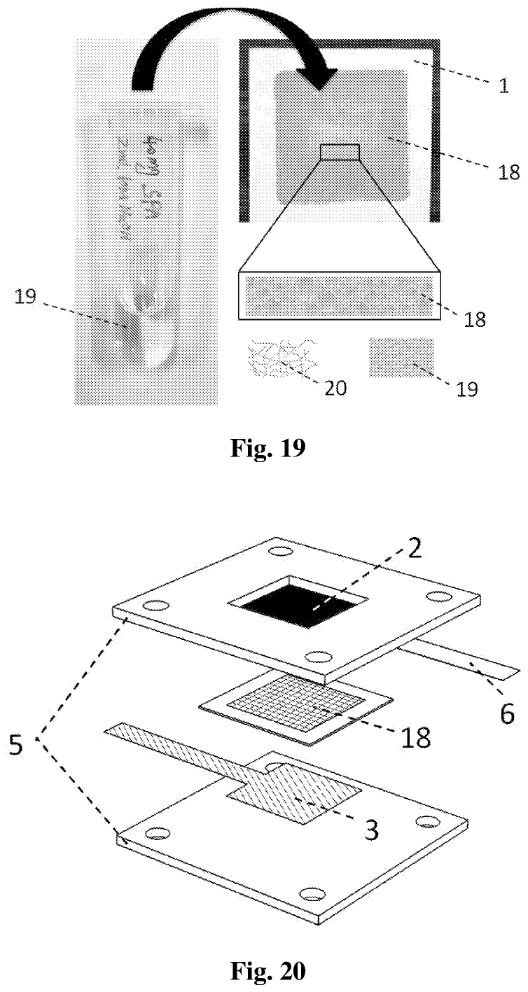

As seen in FIG. 19, a gel electrolyte 19 was prepared first by dissolving a hydrophilic gelling polymer (such as sodium polyacrylate or polyacrylic acid) in an alkaline solution (such as KOH or NaOH). After sufficient stirring, the final product was a transparent gel with high viscosity. Next, a specific amount of the gel electrolyte 19 was deposited into the electrolyte substrate 1. After the gel electrolyte 19 was fully impregnated into the electrolyte substrate 1, it was casted at a specific temperature for a certain period of time to evaporate the excess water inside the gel, in order to achieve the desired solid-state. The final product and the schematic diagram of the PBSE 18 are also shown in FIG. 19, where the gel electrolyte 19 is uniformly distributed inside the cellulose fibre network 20.

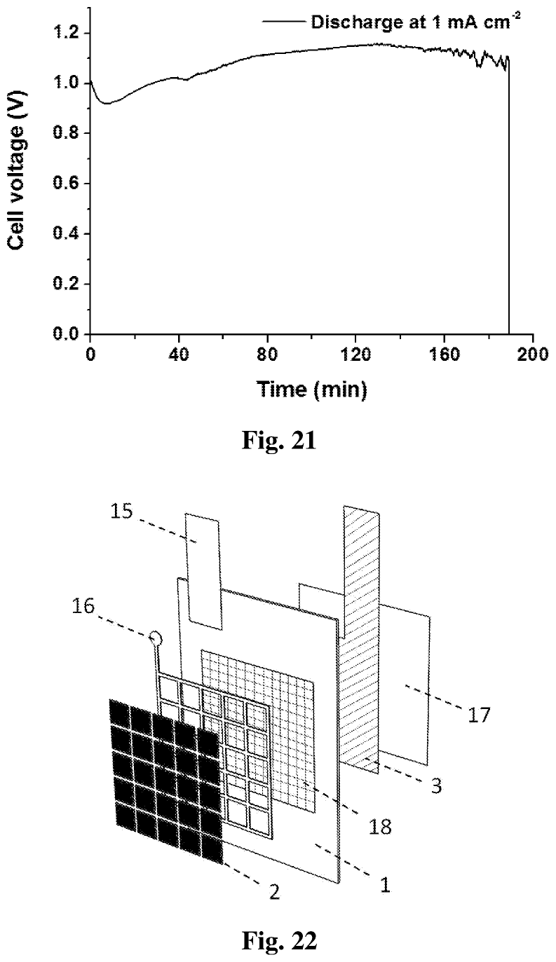

As seen in FIG. 20, an embodiment of the rigid-type battery with liquid-free operation is mainly composed of an aluminium anode 3, an air-breathing cathode 2, a PBSE 18, a cathode current collector 6 and the external battery shell 5, which is very similar to the embodiment illustrated in FIG. 2. In addition, the embodiments of rigid-type battery and battery packs in FIGS. 5, 6, 7, 9 and 10 can also be made liquid-free operation in the same way. Currently, this battery could obtain an OCV of 1.5 V, a peak power density of 3.8 mW cm⁻² and a maximum current density around 5 mA cm⁻². Compared with the rigid-type battery with aqueous electrolyte, the power and current output of this battery was limited. However, it is already sufficient for powering various miniwatt devices, which generally require mW or even μW level of power. In the future, the performance can be further improved by optimizing the PBSE 18 itself or employing more efficient ORR catalysts for the cathode 2. FIG. 21 exhibits the galvanostatic discharge curve of the cell at 1 mA cm⁻². With only 3.5 mg Al foil, the present battery can discharge stably for 3 hours around 1.1 V, and the calculated Al specific capacity can be 900.8 mA h g⁻¹. After the discharge, only four elements (Na, Al, H, O) were detected in the used PBSE, which were originated from the cellulose fiber, the gelling polymer, the generated Al(OH)₃ and the remaining NaOH. As a consequence, the used PBSE can be disposed freely without any environmental concerns.

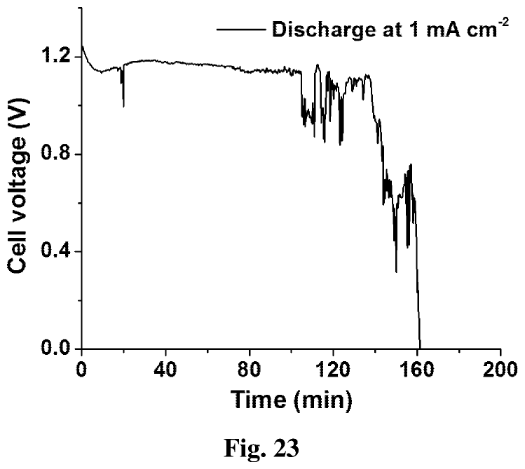

As seen in FIG. 22, an embodiment of the flexible-type battery with liquid-free operation is mainly composed of a PBSE 18 integrated inside the electrolyte substrate 1, a grid-shape current collector 16, an ink-based cathode 2, a cathode connection end 15, an aluminum anode 3 and an adhesive tape 17, which is very similar to the embodiment illustrated in FIG. 11. In addition, the embodiments of flexible-type battery and battery packs in FIGS. 13, 15, 17 and 18 can also be made liquid-free operation in the same way. Compared with the rigid-type battery with PBSE, the present flexible-type battery with PBSE achieves slightly lower performance, with a peak power density of 2.4 mW cm⁻² (37% lower). FIG. 23 shows the galvanostatic discharge curve of the battery at 1 mA cm⁻². When bended by 60° and discharged at 1 mA cm⁻², this flexible battery can be operated for 160 minutes, achieving a high Al specific capacity of 767.5 mA h g⁻¹. The lower power output and Al specific capacity is probably due to the insufficient contact between the cell components in the flexible-type battery, which may be improved by hot-pressing treatment.

The subject invention includes, but is not limited to, the following exemplified embodiments.

Embodiment 1. An aluminum-air battery, the battery comprising:

a hydrophilic and porous electrolyte substrate;

a conductive layer comprising aluminum on one surface of the electrolyte substrate as a battery anode and an oxygen reduction catalyst layer on an opposite surface of the electrolyte substrate as a battery cathode;

an electrolyte either applied to the electrolyte substrate externally or pre-deposited into the electrolyte substrate; and

a battery outer shell.

Embodiment 2. The aluminum-air battery according to embodiment 1, wherein the electrolyte substrate includes one of hydrophilic cellulose paper, cloth, sponge, and cotton.

Embodiment 3. The aluminum-air battery according to any of embodiments 1-2, wherein the anode includes one of an aluminum block, an aluminum plate, or aluminum foil independent from the electrolyte substrate.

Embodiment 4. The aluminum-air battery according to any of embodiments 1-2, wherein the anode includes an aluminum foil pre-fixed onto the electrolyte substrate by taping, pasting, sewing or hot-pressing, or an aluminum foil embedded inside the paper substrate during paper-making, or an aluminum thin-layer pre-deposited onto the electrolyte substrate by physical vapor deposition.

Embodiment 5. The aluminum-air battery according to any of embodiments 1-4, wherein the cathode includes an oxygen reduction catalyst such as platinum, manganese dioxide, a perovskite, a cobalt oxide, or a nitrogen-doped carbon.

Embodiment 6. The aluminum-air battery according to any of embodiments 1-5, wherein the cathode is deposited onto a carbon paper, a carbon cloth, a nickel foam, or a stainless steel foam that is independent from the electrolyte substrate.

Embodiment 7. The aluminum-air battery according to any of embodiments 1-5, wherein the cathode is deposited directly onto the electrolyte substrate.

Embodiment 8. The aluminum-air battery according to any of embodiments 1-7, wherein the electrolyte substrate comprises a grid-shaped current collector.

Embodiment 9. The aluminum-air battery according to any of embodiments 1-8, wherein the electrolyte is an aqueous solution of an alkaline or a salt provided externally.

Embodiment 10. The aluminum-air battery according to any of embodiments 1-8, wherein the electrolyte is pre-deposited into the electrolyte substrate.

Embodiment 11. The aluminum-air battery according to any of embodiments 1-10, wherein a hydrophilic polymer, such as a polyacrylic acid or a sodium polyacrylate, is added into the electrolyte to form a gel electrolyte.

Embodiment 12. The aluminum-air battery according to any of embodiments 1-11, wherein the battery outer shell is configured to allow the shell to be opened or closed.

Embodiment 13. An aluminum-air battery pack, the battery pack comprising:

a plurality of aluminum-air batteries, each battery as described in any one of embodiments 1-12, wherein the plurality of batteries are electrically connected and ionically isolated.

Embodiment 14. The aluminum-air battery pack according to embodiment 13, wherein the plurality of batteries are stacked vertically.

Embodiment 15. The aluminum-air battery pack according to embodiment 13, wherein the plurality of batteries are disposed on the same plane and are adjacent to each other, wherein the plurality of batteries share the same battery shell, wherein the electrolyte is provided to the plurality of batteries, wherein the electrolyte provided to a first battery is separated from the electrolyte provided to a second battery by a barrier.

Embodiment 16. The aluminum-air battery pack according to embodiment 15, wherein the barrier is either a hollow line or a notch cut out from the electrolyte substrate or an impregnated hydrophobic material such as a wax or a polymer.

Embodiment 17. An aluminum-air battery, the battery comprising:

a hydrophilic and porous electrolyte substrate;

a conductive layer comprising aluminum on one surface of the electrolyte substrate as a battery anode and an oxygen reduction catalyst layer on an opposite surface of the electrolyte substrate as a battery cathode;

an electrolyte either applied to the electrolyte substrate externally or pre-deposited into the electrolyte substrate; and

a flexible thin-layer of external packaging.

Embodiment 18. The aluminum-air battery according to embodiment 17, wherein the electrolyte substrate includes one of hydrophilic cellulose paper, cloth, sponge, or cotton.

Embodiment 19. The aluminum-air battery according to any of embodiments 17-18, wherein the battery anode is either an aluminum foil disposed onto one surface of the electrolyte substrate by taping, pasting, sewing or hot-pressing; or an aluminum thin-layer pre-deposited onto one surface of the electrolyte substrate by physical vapor deposition.

Embodiment 20. The aluminum-air battery according to any of embodiments 17-18, wherein the battery anode is an aluminum foil disposed inside the electrolyte substrate during a paper-making process, wherein a first layer of paper pulp is utilized to support the aluminum foil, wherein a second layer of paper pulp is utilized to cover and seal the aluminum foil, wherein the aluminum foil and the first pulp layer and the second pulp layer are pressed and dried to form an integrated product.

Embodiment 21. The aluminum-air battery according to any of embodiments 17-18, wherein the battery anode is deposited onto the electrolyte substrate using an aluminum ink. The aluminum ink is mainly composed of aluminum micro-particles, carbon support, polymer binder and a liquid solvent. The deposition method includes dip-coating, spray-coating, screen printing, inkjet printing, etc. A hot-pressing treatment is adopted after ink deposition to improve the connection among the Al micro-particles, in order to improve the battery performance.

Embodiment 22. The aluminum-air battery according to any of embodiments 17-21, wherein the cathode includes an oxygen reduction catalyst such as manganese dioxide, a perovskite, a cobalt oxide, or a nitrogen-doped carbon, which is deposited onto the opposite surface of the electrolyte substrate.

Embodiment 23. The aluminum-air battery according to any of embodiments 17-22, wherein the cathode is deposited directly onto the electrolyte substrate.

Embodiment 24. The aluminum-air battery according to any of embodiments 17-23, wherein the electrolyte substrate comprises a grid-shaped current collector.

Embodiment 25. The aluminum-air battery according to any of embodiments 17-24, wherein the electrolyte is an aqueous solution of alkaline or salt provided externally before the battery operation

Embodiment 26. The aluminum-air battery according to any of embodiments 17-25, wherein the electrolyte is pre-deposited into the electrolyte substrate.

Embodiment 27. The aluminum-air battery according to any of embodiments 17-26, wherein a hydrophilic polymer, including a polyacrylic acid or a sodium polyacrylate, is added into the electrolyte to form a gel electrolyte.

Embodiment 28. An aluminum-air battery pack, the battery pack comprising:

a plurality of aluminum-air batteries, each battery as described in any one of embodiments 17-27,

wherein the plurality of batteries are electrically connected and ionically isolated.

Embodiment 29. The aluminum-air battery pack according to embodiment 28, wherein the plurality of batteries are stacked vertically.

Embodiment 30. The aluminum-air battery pack according to embodiment 28, wherein the plurality of batteries are disposed on the same plane and are adjacent to each other, wherein the electrolyte is provided to the plurality of batteries, wherein the electrolyte provided to a first battery is separated from the electrolyte provide to a second battery by a barrier.

Embodiment 31. The aluminum-air battery pack according to embodiment 30, wherein the barrier is either a hollow line or a notch cut out from the electrolyte substrate or an impregnated hydrophobic material such as a wax or a polymer.

Embodiment 32. A paper-based solid electrolyte, comprising:

an electrolyte substrate according to embodiment 2 or 18, pre-deposited with a gel electrolyte, wherein the gel electrolyte comprises a gelling agent such as sodium polyacrylate and an alkaline such as sodium hydroxide.

Embodiment 33. A rigid-type paper-based aluminum-air battery with a paper-based solid electrolyte, comprising

an aluminum anode according to embodiments 3-4;

an air-breathing cathode according to embodiments 5-8;

a paper-based solid electrolyte according to embodiment 32 sandwiched between the aluminum anode and the air-breathing cathode; and

a battery outer shell according to embodiment 12.

Embodiment 34. A flexible-type paper-based aluminum-air battery with a paper-based solid electrolyte, comprising

an aluminum anode according to embodiments 19-21;

an air-breathing cathode according to embodiments 22-24;

a paper-based solid electrolyte according to embodiment 32 sandwiched between the aluminum anode and the air-breathing cathode; and

a flexible thin-layer of external packaging.

Embodiment 35. A paper-based aluminum-air battery pack with a paper-based solid electrolyte, comprising:

a plurality of aluminum-air batteries according to embodiment 33 or 34,

wherein the plurality of batteries are electrically connected and ionically isolated.

It should be understood that the examples and embodiments described herein are for illustrative purposes only and that various modifications or changes in light thereof will be suggested to persons skilled in the art and are to be included within the spirit and purview of this application.

### REFERENCES

[1] “Paper-based, printed zinc-air battery”, Journal of Power Sources 194 (2009) 1135-1141.
[2] “A paper based self-pumping and self-breathing fuel cell using pencil stroked graphite electrodes”, Lab Chip, 2014, 14, 1661-1664.
[3] “Microfluidic fuel cells on paper, meeting the power needs of next generation lateral flow devices”, Energy Environ. Sci., 2014, 7, 1744-1749.
[4] “A microfluidic direct formate fuel cell on paper”, Electrophoresis 2015, 36, 1825-1829.
[5] “Disposable hydrogen fuel cells for powering next-generation lateral flow devices”, Transducers 2015, Anchorage, Ak., USA, Jun. 21-25, 2015.
[6] “A microfluidic galvanic cell on a single layer of paper”, Journal of Power Sources 318 (2016) 163-169.
[7] “An improved alkaline direct formate paper microfluidic fuel cell”, Electrophoresis 2016, 37, 504-510.
[8] “Paper-based enzymatic microfluidic fuel cell, From a two-stream flow device to a single-stream lateral flow strip”, Journal of Power Sources 326 (2016) 410-416.
[9] “Paper-based membraneless hydrogen peroxide fuel cell prepared by micro-fabrication”, Journal of Power Sources 301 (2016) 392-395.
[10] “A Metal-Free and Biotically Degradable Battery for Portable Single-Use Applications”, Adv. Energy Mater. 2017, 1700275.
[11] “Paper-based microfluidic biofuel cell operating under glucose concentrations within physiological range”, Biosensors and Bioelectronics 90 (2017) 475-480.
[12] “Single-use paper-based hydrogen fuel cells for point-of-care diagnostic applications”, Journal of Power Sources 342 (2017) 442-451.
[13] “Two-step activation of paper batteries for high power generation, design and fabrication of biofluid- and water-activated paper batteries”, J. Micromech. Microeng. 16 (2006) 2312-2317.
[14] “Ultrafast All-Polymer Paper-Based Batteries”, Nano Lett., Vol. 9, No. 10, 2009
[15] “From Paper to Paper-like Hierarchical Anatase TiO₂ Film Electrode for High-Performance Lithium-Ion Batteries”, J. Phys. Chem. C 2012, 116, 17440-17447.

1. An aluminum-air battery, the battery comprising:
a hydrophilic and porous electrolyte substrate;
a conductive layer comprising aluminum on one surface of the electrolyte substrate as a battery anode and an oxygen reduction catalyst layer on an opposite surface of the electrolyte substrate as a battery cathode;
an electrolyte either applied to the electrolyte substrate externally or pre-deposited into the electrolyte substrate; and
a battery outer shell.

2. The aluminum-air battery of claim 1, wherein the electrolyte substrate includes one of hydrophilic cellulose paper, cloth, sponge, or cotton.

3. The aluminum-air battery of claim 1, wherein the anode includes one of an aluminum block, an aluminum plate, or aluminum foil independent from the electrolyte substrate.

4. The aluminum-air battery of claim 1, wherein the anode includes an aluminum foil pre-fixed onto the electrolyte substrate by taping, pasting, sewing or hot-pressing, or an aluminum foil embedded inside the paper substrate during paper-making, or an aluminum thin-layer pre-deposited onto the electrolyte substrate by physical vapor deposition.

5. The aluminum-air battery according to claim 1, wherein the cathode includes an oxygen reduction catalyst, such as platinum, a manganese dioxide, a perovskite, a cobalt oxide, or a nitrogen-doped carbon.

6. The aluminum-air battery according to claim 1, wherein the cathode catalyst layer is deposited onto one of a carbon paper, a carbon cloth, a nickel foam, or a stainless steel foam that is independent from the electrolyte substrate.

7. The aluminum-air battery according to claim 1, wherein the cathode is deposited directly onto the electrolyte substrate.

8. The aluminum-air battery according to claim 1, wherein the electrolyte substrate comprises a grid-shaped current collector.

9. The aluminum-air battery according to claim 1, wherein the electrolyte is an aqueous solution of an alkaline or a salt provided externally.

10. The aluminum-air battery according to claim 1, wherein the electrolyte is pre-deposited into the electrolyte substrate.

11. The aluminum-air battery according to claim 1, wherein a hydrophilic polymer, such as a polyacrylic acid or a sodium polyacrylate, is added into the electrolyte to form a gel electrolyte.

12. The aluminum-air battery according to claim 1, wherein the battery outer shell is configured to allow the shell to be opened and closed.

13. An aluminum-air battery pack, the battery pack comprising:
a plurality of aluminum-air batteries, each battery as described in claim 1,
wherein the plurality of batteries are electrically connected and ionically isolated.

14. The aluminum-air battery pack of claim 13, wherein the plurality of batteries are stacked vertically.

15. The aluminum-air battery pack of claim 13, wherein the plurality of batteries are disposed on the same plane and are adjacent to each other, wherein the plurality of batteries share the same battery shell, wherein the electrolyte is provided to the plurality of batteries, wherein the electrolyte provided to a first battery is separated from the electrolyte provide to a second battery by a barrier.

16. The aluminum-air battery pack of claim 15, wherein the barrier is either a hollow line or a notch cut out from the electrolyte substrate or an impregnated hydrophobic material optionally including a wax or a polymer.

17. An aluminum-air battery, the battery comprising:
a hydrophilic and porous electrolyte substrate;
a conductive layer comprising aluminum on one surface of the electrolyte substrate as a battery anode, and an oxygen reduction catalyst layer on an opposite surface of the electrolyte substrate as a battery cathode;
an electrolyte either applied to the electrolyte substrate externally or pre-deposited into the electrolyte substrate; and
a flexible thin-layer of external packaging.

18. The aluminum-air battery of claim 17, wherein the electrolyte substrate includes one of hydrophilic cellulose paper, cloth, sponge, or cotton.

19. The aluminum-air battery of claim 17, wherein the battery anode is either an aluminum foil disposed onto one surface of the electrolyte substrate by taping, pasting, sewing or hot-pressing; or an aluminum thin-layer pre-deposited onto one surface of the electrolyte substrate by physical vapor deposition.

20. The aluminum-air battery of claim 17, wherein the battery anode is an aluminum foil disposed inside the electrolyte substrate during a paper-making process, wherein a first layer of paper pulp is utilized to support the aluminum foil, wherein a second layer of paper pulp is utilized to cover and seal the aluminum foil, wherein the aluminum foil, the first pulp layer, and the second pulp layer are pressed and dried to form an integrated product.

21. The aluminum-air battery according to claim 17, wherein the battery anode is deposited onto the electrolyte substrate using an aluminum ink comprising aluminum micro-particles, carbon support, polymer binder, and a liquid solvent; wherein the deposition method comprises any of dip-coating, spray-coating, screen printing, and inkjet printing; and wherein hot-pressing treatment is adopted after ink deposition to improve the connection among the aluminum micro-particles.

22. The aluminum-air battery according to claim 17, wherein the cathode includes an oxygen reduction catalyst such as platinum, a manganese dioxide, a perovskite, a cobalt oxide, or a nitrogen-doped carbon, that is deposited onto the opposite surface of the electrolyte substrate.

23. The aluminum-air battery according to claim 17, wherein the cathode catalyst layer is deposited directly onto the electrolyte substrate.

24. The aluminum-air battery according to claim 17, wherein the electrolyte substrate comprises a grid-shaped current collector.

25. The aluminum-air battery according to claim 17, wherein the electrolyte is an aqueous solution of an alkaline or a salt provided externally.

26. The aluminum-air battery according to claim 17, wherein the electrolyte is pre-deposited into the electrolyte substrate.

27. The aluminum-air battery according to claim 17, wherein a hydrophilic polymer, including a polyacrylic acid or a sodium polyacrylate, is added into the electrolyte to form a gel electrolyte.

28. An aluminum-air battery pack, the battery pack comprising:
a plurality of aluminum-air batteries, each battery as described in claim 17,
wherein the plurality of batteries are electrically connected and ionically isolated.

29. The aluminum-air battery pack of claim 28, wherein the plurality of batteries are stacked vertically.

30. The aluminum-air battery pack of claim 28, wherein the plurality of batteries are disposed on the same plane and are adjacent to each other, wherein the electrolyte is provided to the plurality of batteries, wherein the electrolyte provided to a first battery is separated from the electrolyte provide to a second battery by a barrier.

31. The aluminum-air battery pack of claim 30, wherein the barrier is either a hollow line or a notch cut out from the electrolyte substrate or an impregnated hydrophobic material such as a wax or a polymer.

32. A paper-based solid electrolyte, comprising:
an electrolyte substrate according to claim 2, pre-deposited with a gel electrolyte, wherein the gel electrolyte comprises a gelling agent such as sodium polyacrylate and an alkaline such as sodium hydroxide.

33. A rigid-type paper-based aluminum-air battery with a paper-based solid electrolyte, comprising
a conductive layer comprising aluminum as a battery anode on one surface of a paper-based electrolyte substrate;
an air-breathing battery cathode comprising an oxygen reduction catalyst layer on an opposite surface of the paper-based electrolyte substrate,
such that the paper-based solid electrolyte is sandwiched between the aluminum battery anode and the air-breathing battery cathode; and
a battery outer shell configured to allow the shell to be opened and closed.

34. A flexible-type paper-based aluminum-air battery with a paper-based solid electrolyte, comprising
an aluminum battery anode, comprising either (1) an aluminum foil disposed onto one surface of a paper-based solid electrolyte by taping, pasting, sewing or hot-pressing; or an aluminum thin-layer pre-deposited onto one surface of a paper-based solid electrolyte by physical vapor deposition; (2) an aluminum foil disposed inside a paper-based solid electrolyte during a paper-making process, wherein a first layer of paper pulp is utilized to support the aluminum foil, wherein a second layer of paper pulp is utilized to cover and seal the aluminum foil, wherein the aluminum foil, the first pulp layer, and the second pulp layer are pressed and dried to form an integrated product; or (3) an aluminum ink deposited on a paper-based solid electrolyte, the aluminum ink comprising aluminum micro-particles, carbon support, polymer binder, and a liquid solvent; wherein the deposition method comprises any of dip-coating, spray-coating, screen printing, and inkjet printing; and wherein hot-pressing treatment is adopted after ink deposition to improve the connection among the aluminum micro-particles;
an air-breathing battery cathode comprising an oxygen reduction catalyst;
wherein at least a portion of the paper-based solid electrolyte is sandwiched between the aluminum battery anode and the air-breathing battery cathode; and
a flexible thin-layer of external packaging.

35. An paper-based aluminum-air battery pack with a paper-based solid electrolyte, comprising:
a plurality of aluminum-air batteries according to claim 33,
wherein the plurality of batteries are electrically connected and ionically isolated.

36. An paper-based aluminum-air battery pack with a paper-based solid electrolyte, comprising:
a plurality of aluminum-air batteries according to claim 34,
wherein the plurality of batteries are electrically connected and ionically isolated.
